(19) United States
(12) Patent Application Publication
(10) Pub. No.: US 2007/0134574 A1
(43) Pub. Date: Jun. 14, 2007

(54) Method of manufacturing organic thin film transistor

(75) Inventors: Jung Hun Lee, Daejeon-city (KR); Seong Hyun Kim, Daejeon-city (KR); Jae Bon Koo, Daejeon-city (KR)

Correspondence Address: LOWE HAUPTMAN BERNER, LLP, 1700 DIAGONAL ROAD, SUITE 300, ALEXANDRIA, VA, 22314, US

(73) Assignee: ELECTRONICS AND TELECOMMUNICATIONS RESEARCH INSTITUTE, Daejeon-city (KR)

(21) Appl. No.: 11/635,068

(22) Filed: Dec. 7, 2006

(30) Foreign Application Priority Data
Dec. 7, 2005 (KR) 10-2005-0118791
Jun. 27, 2006 (KR) 10-2006-0058094
Mar. 27, 2006 (KR) 10-2006-0027358

(51) Int. Cl. G03G 15/08; G03G 15/04

(52) U.S. Cl. 430/66

(57) ABSTRACT

Provided is a method of manufacturing an organic thin film transistor (OTFT). The method comprises forming all components in the OTFT including electrodes, an insulating layer, and an organic layer using laser printing. The laser printing allows formation of a fine pattern by selectively scattering toner only on a portion of a substrate irradiated by a laser beam while eliminating the need for a separate drying process by fixing the toner to the substrate using a fixing roller.

### CROSS-REFERENCE TO RELATED PATENT APPLICATION

This application claims the benefit of Korean Patent Application No. 10-2005-0118791, filed on Dec. 7, 2005 and 10-2006-0058094, filed on June 27 in the Korean Intellectual Property Office, the disclosures of which are incorporated herein in their entirety by reference.

### BACKGROUND OF THE INVENTION

1. Field of the Invention

The present invention relates to a method of manufacturing an organic thin film transistor (OTFT), and more particularly, to a method of manufacturing an OTFT using a laser printing technique.

2. Description of the Related Art

Research is being actively carried out on organic thin film transistors (OTFTs) that are used as driving elements for next-generation display devices. An OTFT uses an organic semiconductor layer instead of a silicon semiconductor layer. OTFTs can be classified into low-molecule and high-molecule type OTFTs depending on the material used to form an organic layer.

An organic electrolumnescence (OEL) display using an OTFT as a switching element includes upper and lower substrates, opposing upper and lower electrodes respectively disposed on the upper and lower substrates, at least two OTFTs disposed on either the upper or lower substrate, a capacitor, and an organic layer interposed between the upper and lower substrates.

Conventionally, the organic layer is patterned by means of vacuum evaporation using a shadow mask or common optical etching to form an organic pattern.

However, conventional vacuum evaporation using a shadow mask makes it difficult to form a fine organic pattern which is required for achieving a full color. The vacuum evaporation also increases process time because an organic layer needs to be heat dried for a predetermined time after deposition. On the other hand, use of optical etching may cause damage to the organic layer due to a developer or etchant solution, thus resulting in degradation of light-emission characteristics such as reduced life span and emission efficiency.

Furthermore, because the steps for forming electrodes, an insulating layer, and an organic layer in a conventional OTFT are performed in different equipments, the length of a path along which a substrate is transferred is lengthened, thus resulting in contamination of a substrate surface during transfer. Furthermore, the transfer time is increased, thus increasing the total manufacturing time.

### SUMMARY OF THE INVENTION

The present invention provides a method of manufacturing an organic thin-film transistor (OTFT) that enables formation of a fine organic pattern which is required to achieve a good electrical characteristics and prevents damage to an organic layer by eliminating the need for an etching step.

The present invention also provides a method of manufacturing an OTFT that can reduce the manufacturing process time.

According to an aspect of the present invention, there is provided a method of fabricating an OTFT comprising forming an organic layer by scattering toner on a substrate.

The toner is scattered on the predetermined portion of the substrate using a laser printer. The laser printer includes: an exposure unit irradiating a laser beam according to externally received print data; a photoreceptor drum creating an electrostatic latent image using the laser beam irradiated by the exposure unit; a developer spraying toner on the photoreceptor drum in order to convert the electrostatic latent image into a visible image; a transfer roller transferring the toner sprayed on the photoreceptor drum to the substrate; and a fixing roller thermally fusing the transferred image to the substrate.

The toner is an ultrafine particulated polymer or monomer material for forming an organic layer or a compound containing the polymer and monomer materials. The toner may contain toner for forming an electrode layer, toner for forming an insulating layer, and toner for forming the semiconductor layer.

The toner scattered on the substrate is dried and fixed to the substrate by the fixing roller, thus eliminating the need for a separate dry process.

The substrate is a flexible substrate that can move within the laser printer.

According to another aspect of the present invention, there is provided a method of fabricating an organic thin-film transistor (OTFT) by scattering toner using laser printing, the method including: supplying a substrate; forming a gate electrode on the substrate; forming an insulating layer on the gate electrode; forming source and drain electrodes on predetermined portions of the insulating layer; and forming an organic semiconductor layer on the insulating layer on which the source and drain electrodes have been formed. In this case, at least one of the gate electrode, the insulating layer, the source and drain electrodes, and the organic layer is formed by scattering toner using laser printing. The sequence can change: forming a source and drain electrode on the substrate; forming an organic semiconductor layer on the source and drain electrode; forming an insulating layer on the organic semiconductor layer; and forming a gate electrode on the insulating layer.

The gate electrode, the insulating layer, the source and drain electrodes, and the organic layer may be all formed within a single laser printer.

### BRIEF DESCRIPTION OF THE DRAWINGS

The above and other features and advantages of the present invention will become more apparent by describing in detail exemplary embodiments thereof with reference to the attached drawings in which:

FIG. 1 is a cross-sectional view illustrating a method of manufacturing an organic thin-film transistor (OTFT) according to an embodiment of the present invention;

FIG. 2 is a schematic diagram of a laser printer according to an embodiment of the present invention;

FIGS. 3A and 3B are diagrams illustrating steps of a method of manufacturing an OTFT using a laser printer according to an embodiment of the present invention; and

FIG. 4 is a diagram for explaining a method of manufacturing an OTFT using a laser printer according to another embodiment of the present invention.

### DETAILED DESCRIPTION OF THE INVENTION

The present invention will now be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art. Like reference numerals in the drawings denote like elements, and thus their description will be omitted.

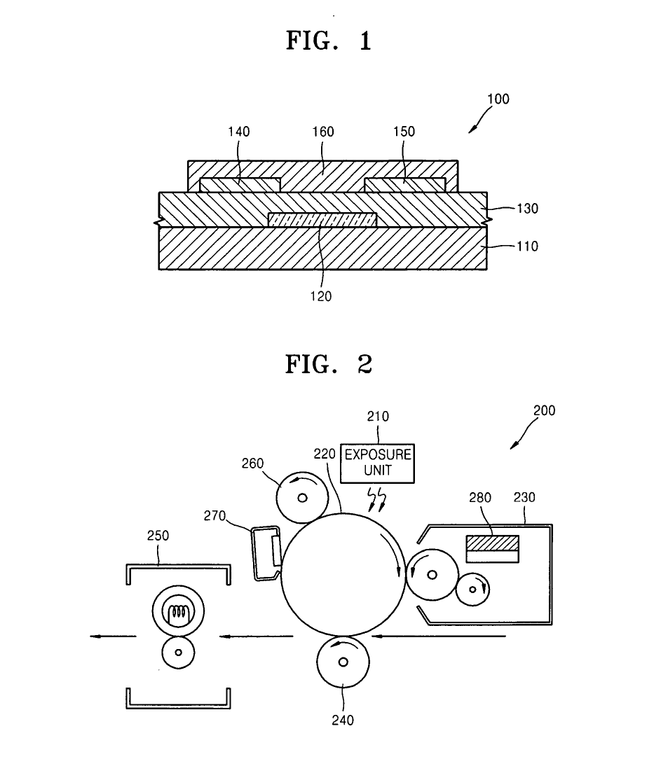

FIG. 1 is a cross-sectional view illustrating a method of manufacturing an organic thin-film transistor (OTFT) according to an embodiment of the present invention.

Referring to FIG. 1, a substrate 110 is prepared. The substrate 110 may be a flexible substrate made of plastic, rubber, foil, or other flexible material. A gate electrode 120 is formed on a predetermined portion of the substrate 110 and a gate insulating layer 130 is formed on the gate electrode 120 and exposed portions of the substrate 110. A source electrode 140 and a drain electrode 150 are formed on predetermined portions of the gate insulating layer 130 and spaced apart from each other. The gate electrode 120 may be disposed between the source electrode 140 and the drain electrode 150. An organic layer 160 is formed on the resulting structure in which the source electrode 140 and the drain electrode 150 have been arranged on the gate insulating layer 130. The organic layer 160 may be formed of an ultrafine particulated polymer, monomer, or a combination thereof. The organic layer 160 may be formed by laser printing using the ultrafine particulated polymer, monomer, or combination thereof as toner.

FIG. 2 is a schematic diagram of a laser printer 200 according to an embodiment of the present invention. Referring to FIG. 2, the laser printer 200 includes an exposure unit 210 irradiating a laser beam according to externally received print data, a photoreceptor drum 220 creating an electrostatic latent image using the laser beam irradiated by the exposure unit 210, a developer 230 spraying toner on the photoreceptor drum 220 in order to convert the electrostatic latent image formed on the photoreceptor drum 220 into a visible image, a transfer roller 240 transferring the toner sprayed on the photoreceptor drum 220 to the substrate (110 of FIG. 1), and a fixing roller 250 thermally fusing the transferred image to the substrate 110.

The laser printer 200 further includes a charging roller 260 for electrically charging the photoreceptor drum 220 by placing the charging roller 260 in contact with the photoreceptor drum 220 and applying voltage between them a cleaning blade removing developing agent remaining on the photoreceptor drum 220, and a cartridge 280 holding the toner.

The exposure unit 210 irradiates a laser beam in order to form a pattern of the organic layer. The toner housed in the cartridge 280 is ultrafine particulate toner for forming the organic layer 160. For example, the toner may be an ultrafine particulated polymer, monomer, or a combination thereof. The substrate 110 may be a flexible substrate that can pass between the photoreceptor drum 220 and the transfer roller 240 within the laser printer 200.

Furthermore, the fixing roller 250 may be maintained at a temperature of 80 to 150° C. so as to allow the transferred image to be dried and thermally fused to the substrate 110 as the substrate 110 passes through the fixing roller 250.

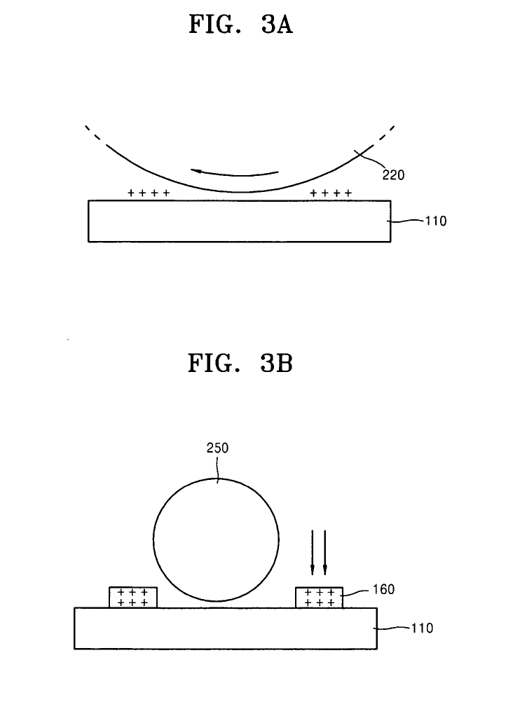

FIGS. 3A and 3B are diagrams illustrating steps of a method of manufacturing an OTFT using the laser printer 200 according to an embodiment of the present invention. The method of manufacturing an OTFT will now be described with reference to FIGS. 2, 3A, and 3B.

Referring to FIG. 3A, when the substrate (110 of FIG. 1) is supplied to the laser printer 200 having the above-mentioned construction from an apparatus (not shown) for supplying a single sheet of substrate, the substrate 110 is absorbed onto the transfer roller (240 of FIG. 2) which is charged to a predetermined polarity due to a difference in charging power. Thereafter, when a laser beam is irradiated by the exposure unit 210 onto the photoreceptor drum 220 which is charged by the charging roller 260, an electrostatic latent image is created on the photoreceptor drum 220 in the form of an organic pattern.

Then, referring to FIG. 3B, a portion of the photoreceptor drum 220 corresponding to the electrostatic latent image is developed with toner using the developer 230. The toner developed on the photoreceptor drum 220 is scattered and transferred to the substrate 110 due to a difference in Coulomb force on the transfer roller 240 to form the organic pattern (160 of FIG. 1). Subsequently, the toner transferred to the substrate, i.e., the organic pattern 160 is thermally fused and fixed onto the substrate 110 as it passes through the fixed roller 250 which is maintained at a temperature of 80 to 150° C.

Although in the above description, an organic layer in an OTFT is formed of an ultrafine particulated polymer or monomer material by means of laser printing, all layers in the OTFT including a gate, a source electrode, a drain electrode, an insulating layer, and an organic layer can be formed of ultrafine particles using the same technique.

More specifically, referring to FIG. 1, the gate electrode 120 is formed by spraying electrode toner (not shown) onto a predetermined portion of the substrate 110 using laser printing and is then fixed by the fixing roller 250. The gate insulating layer 130, the source and drain electrodes 140 and 150, and the organic pattern 160 are sequentially formed using the same technique as described above.

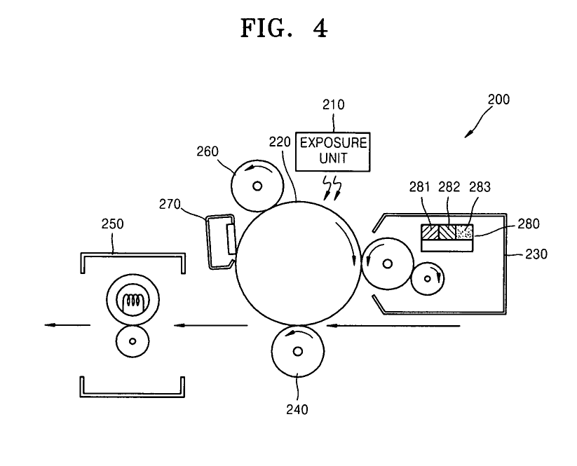

In order to form all layers in the OTFT using a laser printer, the laser printer has the same construction as of the laser printer illustrated in FIG. 4. FIG. 4 is a diagram for explaining a method of manufacturing an OTFT using a laser printer 200 according to another embodiment of the present invention. Referring to FIG. 4, the laser printer 200 basically has the same construction as of the laser printer illustrated in FIG. 2. The cartridge 280 contains toner 281 for forming electrodes, toner 282 for forming an insulating layer, and toner 283 for forming an organic layer. Furthermore, when the gate electrode 120 is made of a different material than the source and drain electrodes 140 and 150, the toner 281 for forming electrodes may contain toner for forming the gate electrode 120 and toner for forming the source/drain electrodes 140 and 150.

In this manner, all components in the OTFT are consecutively formed within a single laser printer using ultrafine particulated toner. Thus, the length of a path along which a substrate is transferred can be shortened, thus reducing contamination on a substrate surface. Furthermore, the laser printing technique allows formation of a fine pattern at the desired position irradiated by the laser beam without a separate substrate alignment process and enables the substrate to be dried as it passes through a fixing roller, thus simplifying the manufacturing process.

As described above, according to the present invention, all layers in an OTFT are formed using laser printing. The laser printing allows formation of a fine pattern by selectively scattering toner only on a portion of a substrate irradiated by a laser beam, thus achieving a full color display. The laser printing eliminates the need for a separate dry process by fixing the toner to the substrate using a fixing roller, thus simplifying the manufacturing process and reducing the total process time. Furthermore, the laser printing eliminates the need for etching, thus preventing damage to an organic layer.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of fabricating an organic thin-film transistor (OTFT) comprising forming an organic layer by scattering toner on a substrate.

2. The method of claim 1, wherein the toner is scattered on the predetermined portion of the substrate using a laser printer.

3. The method of claim 2, wherein the laser printer comprises:
an exposure unit irradiating a laser beam according to externally received print data;
a photoreceptor drum creating an electrostatic latent image using the laser beam irradiated by the exposure unit;
a developer spraying toner on the photoreceptor drum in order to convert the electrostatic latent image into a visible image;
a transfer roller transferring the toner sprayed on the photoreceptor drum to the substrate; and
a fixing roller thermally fusing the transferred image to the substrate.

4. The method of claim 1, wherein the toner is an ultrafine particulated polymer or monomer material for forming an organic layer or a compound containing the polymer and monomer materials.

5. The method of claim 4, wherein the toner contains toner for forming an electrode layer, toner for forming an insulating layer, and toner for forming the organic layer.

6. The method of claim 4, wherein the toner scattered on the substrate is dried and fixed to the substrate by the fixing roller.

7. The method of claim 6, wherein the fixing roller is maintained at a temperature of 80 to 150° C.

8. The method of claim 1, wherein the substrate is a flexible substrate.

9. A method of fabricating an organic thin-film transistor (OTFT) by scattering toner using laser printing, the method comprising:
supplying a substrate;
forming a gate electrode on the substrate;
forming an insulating layer on the gate electrode;
forming source and drain electrodes on predetermined portions of the insulating layer; and
forming an organic layer on the insulating layer on which the source and drain electrodes have been formed,
wherein at least one of the gate electrode, the insulating layer, the source and drain electrodes, and the organic layer is formed by scattering toner using laser printing.

10. The method of claim 9, wherein the gate electrode, the insulating layer, the source and drain electrodes, and the organic layer are all formed within a single laser printer.
